(19) United States
(12) Patent Application Publication
(10) Pub. No.: US 2015/0059333 A1
(43) Pub. Date: Mar. 5, 2015

(54) ENERGY CONVERSION AND ASSOCIATED APPARATUS

(71) Applicant: Richard McMahon, Glasgow (GB)

(72) Inventor: Richard McMahon, Glasgow (GB)

(21) Appl. No.: 13/261,980

(22) PCT Filed: Apr. 30, 2013
(86) PCT No.: PCT/GB2013/051108

§ 371 Date: Oct. 29, 2014

(30) Foreign Application Priority Data
Apr. 30, 2012 (GB) 1207510.7

(51) Int. Cl. F02G 1/04

(52) U.S. Cl. CPC F02G 1/04; F02G 2254/90
USPC 60/508; 60/645

(57) ABSTRACT

Methods and apparatus (10) for providing mechanical energy. The apparatus (10) for providing mechanical energy comprises a motor (11) for providing mechanical energy. The motor (11) comprises a chamber (17, 117, 217, 317, 417) for receiving a fluid to be heated. An amplified stimulated emission radiation source (e.g. a laser and/or a maser) (36, 436) is provided for supplying radiation to the chamber (17, 117, 217, 317, 417).

### FIELD OF THE INVENTION

The present invention relates to improved energy conversion and associated apparatus, particularly, but not exclusively, to an improved motor.

### BACKGROUND TO THE INVENTION

The majority of engines presently in use are reciprocating piston, internal combustion engines. The internal combustion engine works on the principle of a regulated fuel mixture being ignited by a spark in an enclosed chamber. The production of power in an internal combustion engine is combined with fuel combustion and is restricted to every one stroke in four within a combined space.

Whilst being reliable, the internal combustion engine can have relatively poor fuel efficiency, high manufacturing costs and can cause significant environmental pollution. Increasingly stringent emission requirements have necessitated innovations such as catalytic converters, high pressure injection systems, synthetic lubrication oils and highly refined crude oil based fuels, all adding to the manufacturing and running costs.

The external combustion engine operates differently to the internal combustion engine in that combustion of the regulated fuel mixture takes place continuously within its own combustion chamber separately from the power production chamber. The energy transfer from the combustor to the power production/working chamber is enabled by the working fluid via heat exchangers.

The external combustion engine has reduced toxic emissions from the internal combustion engine, and the optimised fuel efficiency enables the use of less refined fuels and results in lower cost fuels. The external combustion engine, as there is no explosion involved, is quieter than the internal combustion engine.

However, the external combustion engine has drawbacks; such as oil degradation, heat exchanger contamination, high friction levels, high volume/weight/cost levels and low heater exchanger system efficiency.

### SUMMARY OF THE INVENTION

According to a first aspect of the invention there is provided an apparatus for providing mechanical energy, the apparatus comprising

a motor for providing mechanical energy, the motor comprising at least one chamber for receiving a fluid to be heated and/or combusted and/or compressed and/or expanded; and

an amplified stimulated emission radiation source (e.g. a laser and/or a maser) for supplying radiation to the chamber.

The radiation may be supplied to the chamber to heat the fluid. The apparatus may be configured to heat the fluid in the chamber with the radiation from the amplified stimulated emission radiation source.

The radiation may be supplied to the chamber to preheat the fluid. The apparatus may be configured to preheat the fluid in the chamber with the radiation from the amplified stimulated emission radiation source. For example, the apparatus may be configured to preheat the fluid in the chamber with the radiation from the amplified stimulated emission radiation source prior to ignition of the fluid.

The radiation may be supplied to the chamber to heat the chamber. The apparatus may be configured to heat the chamber with the radiation from the amplified stimulated emission radiation source. For example, the radiation may be supplied to the chamber prior to and/or during and/or shortly after starting the motor (e.g. to bring the chamber and/or fluid up to a working temperature, such as when the motor has become cold through inoperation). The apparatus may be configured to supply radiation to the chamber prior to and/or upon start-up.

The radiation may be supplied to the chamber to ignite the fluid. The apparatus may be configured to ignite the fluid in the chamber with the radiation from the amplified stimulated emission radiation source.

The radiation may be supplied to the chamber to maintain the chamber. The apparatus may be configured to maintain the chamber with the radiation from the amplified stimulated emission radiation source. For example, the apparatus may be configured to clean the chamber with the radiation from the amplified stimulated emission radiation source, such as by ablation of a surface of the chamber.

The fluid may comprise an inert fluid. The fluid may comprise water and/or steam. The steam may comprise saturated steam. The steam may comprise wet steam.

The fluid may comprise a combustible fluid. The combustible fluid may comprise hydrogen.

The motor may comprise an internal combustion engine.

The motor may comprise an external combustion engine. The motor may be configured to compress a fluid in the chamber, such as with a piston.

The motor may comprise a cylinder defining the chamber. The piston may define an end wall of the chamber.

The motor may be configured to provide the amplified stimulated emission radiation to the chamber for a predetermined interval. The motor may be configured to provide the amplified stimulated emission radiation to the chamber at a predetermined phase or stage of a chamber cycle. For example, where the chamber is a cylinder chamber operable with a piston, the motor may be configured to provide the amplified stimulated emission radiation to the chamber when the piston reaches a predetermined position, such as top dead centre. For example, the motor may comprise a control system (e.g. comprising a switch and/or a timer and/or an electronic controller) such that the radiation source and/or a radiation guide and/or a radiation inlet is activated at a predetermined piston position.

The radiation may comprise a wavelength configured to heat the fluid. For example, where the fluid is steam, the laser may comprise a wavelength of about 1000 nm.

The radiation may comprise a wavelength configured to clean the chamber. For example, the radiation may comprise laser radiation with a low absorption depth, such as a low absorption depth in a chamber surface.

The radiation source may be configured to provide radiation with a wavelength/s in accordance with a surface property of the chamber (e.g. for low absorption depth).

The radiation may comprise multiple wavelengths. Multiple wavelengths may enable different absorption rates. Accordingly, the intensities of radiations at different wavelengths may vary along a path of the radiation through the chamber. For example, radiation at a first wavelength may be more readily absorbed by the fluid, such that the first wavelength may be used to radiate (e.g. heat) the fluid in a first portion of the chamber; and a second wavelength may be used to radiate the fluid in a second portion of the chamber. The first portion may correspond to a first section of a beam path. The second portion may correspond to a second section of a beam path.

The radiation may be divergent.

The radiation may comprise single spatial mode radiation.

The radiation may comprise multiple spatial mode radiation.

The radiation may comprise pulsed radiation and/or scanned radiation. For example, the apparatus may be configured to provide scanned radiation across the chamber. The apparatus may be configured to radially and/or circumferentially and/or spirally scan the radiation.

The motor may comprise the radiation source.

Alternatively the radiation source may be remote from the motor.

The motor may comprise a beam splitter.

The motor may comprise a radiation guide.

The motor may comprise a plurality of chambers. Each chamber may comprise a discrete radiation source. Alternatively, the motor may be configured to supply radiation from a single radiation source to multiple chambers. The motor may be configured to supply radiation from a single radiation source to multiple chambers sequentially. For example, the motor may be configured to selectively guide radiation from a single radiation source to each chamber depending on a phase of each chamber. The motor may be configured to sequentially radiate fluid in sequential chambers, such as adjacent chambers. The motor may be configured to simultaneously radiate fluid in multiple chambers.

The motor may comprise an external combustion compartment. For example, the motor may comprise a hydrogen burner. The motor may be configured to supply an exhaust fluid from the external combustion compartment to the fluid chamber. For example, the motor may comprise an inlet fluid means, such as an inlet pump and/or an inlet fan, for supplying fluid to a chamber inlet.

The motor may be configured to circulate the fluid (which may be a heatable fluid). The motor may comprise an exhaust fluid means, such as an exhaust pump and/or an exhaust fan, for directing chamber exhaust fluid away from a chamber outlet.

The motor may be configured to recirculate the fluid, such as directing chamber exhaust fluid to a chamber inlet.

Energy (e.g. heat) from the internal and/or external combustion engine may be used to heat and/or pressurise the fluid supplied to the chamber (e.g. to heat the fluid in the chamber, such as to pressurise the fluid).

In use, hydrogen may be supplied to the hydrogen burner, such that steam is generated. The steam may be supplied to the fluid chamber, such as via an inlet port by an inlet fan. The chamber may shrink. For example, the chamber may be compressed, such as by a reciprocating piston. The radiation source may be activated to supply radiation to the chamber. The radiation in the chamber may heat the steam. The pressure of the steam in the chamber may increase such that the piston is forced to reciprocate (down). Accordingly mechanical work may be harnessed from the piston. For example, the piston may be connected to a crank shaft such that the crank shaft is rotated by the action of the piston.

The maser may comprise a hydrogen maser.

The amplified stimulated emission radiation source may be battery-powered. The amplified stimulated emission radiation source may be generator-powered. Energy output from the internal and/or external combustion engine may be used to power the amplified stimulated emission radiation source.

The motor may be configured to distribute radiation throughout the chamber.

The motor may be configured to distribute the radiation evenly.

The motor may be configured to concentrate the radiation.

The motor may be configured to concentrate the radiation in a predetermined area or predetermined volume of the chamber.

The motor may be configured to distribute the radiation in the chamber according to a distribution of fluid in the chamber.

The motor may be configured to heat the fluid in the chamber.

The motor may be configured to heat the fluid evenly.

The motor may be configured to sequentially radiate fluid in different portions of the chamber. The motor may be configured to progressively radiate fluid in different portions of the chamber. The motor may be configured to progressively radially radiate fluid in different portions of the chamber. The motor may be configured to spirally radiate fluid in different portions of the chamber. The motor may be configured to divergently radiate fluid in different portions of the chamber. The motor may be configured to convergently radiate fluid in different portions of the chamber.

The motor may be configured to radiate fluid within the chamber according to a change in volume of fluid in the chamber. For example, the motor may be configured to radiate fluid in a first portion of the chamber during a first stage of radiation, such as during a reduction in the volume of the chamber (e.g. during a first stage of compression by the piston). The motor may be configured to radiate fluid in a second portion of the chamber during a second stage of radiation, such as when the piston is at top dead centre, or when the chamber comprises a minimum volume.

The motor may comprise a filter. The motor may comprise a filter to filter fluid at and/or prior to chamber entry. Additionally or alternatively, the motor may comprise a filter to filter fluid upon and/or after chamber exit.

The motor may comprise a motor inlet for receiving fluid (e.g. combustible fluid). The motor may comprise a motor outlet (e.g. exhaust valve) for releasing fluid (e.g. a combusted fluid and/or an uncombusted fluid; and/or a product or component thereof).

The motor may be configured to expel fluid form the chamber at shut-down. Expelling fluid from the chamber at shut-down may prevent a formation of fluid condensation within the chamber.

The motor may be configured to heat the chamber and/or fluid at start-up. Heating the fluid and/or the chamber at start-up may allow compensation of any temperature and/or pressure decrease due to a period of inoperation of the motor.

According to a further aspect of the invention there is provided a method of providing mechanical energy, the method comprising:

supplying radiation from an amplified stimulated emission radiation source to a chamber of a motor;

heating and/or igniting and/or pressurising a fluid in the chamber with the radiation; and/or

heating and/or maintaining the chamber with the radiation.

According to a further aspect of the invention there is provided a motor chamber for providing mechanical energy, the chamber being for receiving a fluid to be heated and/or combusted and/or compressed and/or expanded, wherein the chamber is configured to distribute radiation from an amplified stimulated emission radiation source (e.g. a laser and/or a maser) to heat and/or combust and/or pressurise the fluid and/or to radiate the chamber.

The chamber may be configured to distribute radiation throughout the chamber.

The chamber may be configured to distribute the radiation evenly.

The chamber may be configured to concentrate the radiation.

The chamber may be configured to concentrate the radiation in a predetermined area or predetermined volume of the chamber.

The chamber may be configured to distribute the radiation in the chamber according to a distribution of fluid in the chamber.

The chamber may be configured to heat the fluid in the chamber.

The chamber may be configured to heat the fluid evenly.

The chamber may comprise a cylinder chamber. The chamber may be defined by a cylinder. The chamber may be defined by a cylinder and a piston.

The chamber may comprise at least one side wall. The chamber may comprise an end wall. The chamber may comprise a moveable wall, such as a piston crown or head.

The chamber may comprise a fluid inlet port. The chamber may comprise a fluid outlet port.

The fluid inlet and/or outlet port may be configured to be in fluid communication with the chamber according to a control system. The control system may comprise a position of the piston and/or a stage of radiating the fluid in the chamber.

The chamber may be configured to sequentially radiate fluid in different portions of the chamber. The chamber may be configured to progressively radiate fluid in different portions of the chamber. The chamber may be configured to progressively radially radiate fluid in different portions of the chamber. The chamber may be configured to spirally radiate fluid in different portions of the chamber. The chamber may be configured to divergently radiate fluid in different portions of the chamber. The chamber may be configured to convergently radiate fluid in different portions of the chamber.

The chamber may be configured to radiate fluid within the chamber according to a change in volume of fluid in the chamber. For example, the chamber may be configured to radiate fluid in a first portion of the chamber during a first stage of radiation, such as during a reduction in the volume of the chamber (e.g. during a first stage of compression by the piston). The chamber may be configured to radiate fluid in a second portion of the chamber during a second stage of radiation, such as when the piston is at top dead centre, or when the chamber comprises a minimum volume.

The first and/or second portion/s of the chamber may be an annular portion/s. The first and/or second portion/s of the chamber may be a radial portion/s. The first and/or second portion/s of the chamber may be a segment portion/s. The first and/or second portion/s of the chamber may be an axial portion/s. The first and/or second portion/s of the chamber may be a spiral portion/s. The first and/or second portion/s of the chamber may be a helical portion/s. The first and/or second portion/s of the chamber may be a central portion/s. The first portion may comprise the second portion.

The chamber may comprise a concave surface. The chamber may comprise a concave surface configured to concentrate the radiation, such as towards a central portion of the chamber. The moveable wall and/or the chamber end wall and/or the side wall/s may comprise a concave surface. The chamber may comprise a convex surface. The chamber may comprise a convex surface configured to spread the radiation. The moveable wall and/or the chamber end wall and/or the side wall/s may comprise a convex surface.

The moveable wall may comprise an axially and/or laterally and or rotationally asymmetric profile relative to a longitudinal axis of the chamber. The moveable wall may comprise an axially and/or laterally and or rotationally symmetric profile relative to a longitudinal axis of the chamber.

The chamber may comprise a reflective surface. For example, the chamber may comprise a mirror configured to reflect the radiation. The moveable wall and/or the chamber end wall and/or the side wall/s may comprise the reflective surface. The reflective surface may be angled with respect to the incident radiation beam (e.g. to redirect the radiation beam towards a non-radiated chamber portion, such as away from a chamber radiation inlet).

The chamber may comprise a profiled surface, such as a textured or grooved surface (e.g. moveable end wall and/or the chamber end wall and/or the side wall/s). The magnitude (or amplitude) and/or pitch of the profiled surface may be configured according to the radiation wavelength/s. For example, the profiled surface may comprise a structure with a pitch and/or order of magnitude larger than the radiation wavelength/s. The profiled surface may comprise a structure with a pitch and/or order of magnitude larger similar to the radiation wavelength/s. The profiled surface may comprise a structure with a pitch and/or order of magnitude less than the radiation wavelength/s.

The magnitude and/or pitch of the profiled surface may be configured according to the beam diameter and/or width. For example, the profiled surface may comprise a structure with a pitch and/or order of magnitude larger than the beam diameter and/or width. The profiled surface may comprise a structure with a pitch and/or order of magnitude larger similar to the beam diameter and/or width. The profiled surface may comprise a structure with a pitch and/or order of magnitude less than the beam diameter and/or width.

The chamber may be configured to be ablated by the radiation. For example, the chamber may be configured such that radiation reaches substantially the entire surface/s of the chamber. The chamber may be configured such that the chamber surface/s receives a substantially homogenous dosage of radiation.

The chamber may be configured such that the chamber surface/s receive a radiation dosage corresponding to a surface property. For example, the chamber may be configured such that a first chamber portion prone to fouling or contaminant concentration (such as a transition—e.g. an edge or area adjacent an outlet) receives a higher radiation dosage than a second chamber portion less prone to fouling or contaminant concentration (such as an intermediate sidewall portion).

The chamber may be microscopic.

The chamber may be nanoscopic.

The invention includes one or more corresponding aspects, embodiments or features in isolation or in various combinations whether or not specifically stated (including claimed) in that combination or in isolation. For example, it will readily be appreciated that features recited as optional with respect to the first aspect may be additionally applicable with respect to the other aspects without the need to explicitly and unnecessarily list those various combinations and permutations here.

In addition, corresponding means for performing one or more of the discussed functions are also within the present disclosure.

It will be appreciated that one or more embodiments/aspects may be useful in providing mechanical energy.

The above summary is intended to be merely exemplary and non-limiting.

### BRIEF DESCRIPTION OF THE DRAWINGS

Embodiments of the present invention will now be described with reference to the accompanying drawings in which:

FIG. 1 is a schematic of an apparatus according to a first embodiment of the present invention;

FIG. 2 is a partial view of the apparatus of FIG. 1;

FIG. 3 is a view of a cylinder of the apparatus of FIG. 1 in a first configuration;

FIG. 4 is a view of a cylinder of the apparatus of FIG. 1 in a second configuration;

FIG. 5 is a view of a cylinder of the apparatus of FIG. 1 in a third configuration;

FIG. 6 is a view of a cylinder of the apparatus of FIG. 1 in a fourth configuration;

FIG. 7 is a cross-sectional view of a cylinder in accordance with an embodiment of the invention;

FIG. 8 is a cross-sectional view of the cylinder of FIG. 7, showing a portion of a radiation distribution in a cylinder chamber;

FIG. 9 is a plan view of the cylinder of FIG. 7, showing a portion of a radiation distribution in a cylinder chamber;

FIG. 10 is a graph showing a radiation distribution in a cylinder chamber;

FIG. 11 is a cross-sectional view of a cylinder in accordance with an embodiment of the invention, showing a portion of a radiation distribution in a cylinder chamber;

FIG. 12 is a cross-sectional view of a cylinder in accordance with an embodiment of the invention, showing a portion of a radiation distribution in a cylinder chamber; and

FIG. 13 is a perspective view of a cylinder in accordance with an embodiment of the invention, showing an indicative surface of a piston head in a cylinder chamber.

### DETAILED DESCRIPTION OF THE DRAWINGS

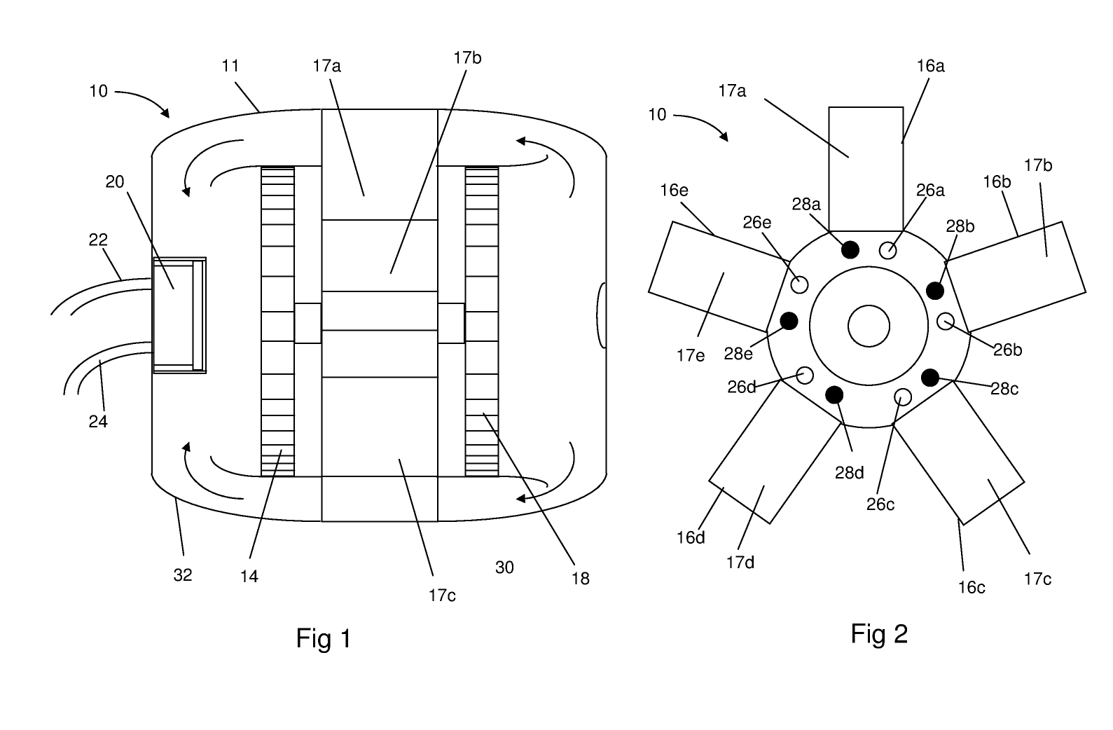

FIG. 1 shows a schematic of an apparatus for providing mechanical energy, generally indicated by reference 10, according to a first embodiment of the present invention. The apparatus 10 for providing mechanical energy comprises a motor 11 for providing mechanical energy. The motor 11 comprises a chamber 17 for receiving a fluid to be heated. An amplified stimulated emission radiation source (not shown in FIG. 1) is provided for supplying radiation to the chamber 17.

The apparatus 10 further comprises an inlet fan 14 to direct fluid towards a series of cylinders 16. In the embodiment shown, the apparatus 10 comprises a series of five radially-arranged cylinders 16a, 16b, 16c, 16d, 16e; each cylinder comprising a chamber 17a, 17b, 17c, 17d, 17e. The apparatus further comprises an exhaust fan 18 to direct fluid away from the series of cylinders 16.

In the embodiment shown, the apparatus 10 further comprises a combustion engine in the form of a hydrogen burner 20. Accordingly, hydrogen and oxygen (or air) are supplied to the apparatus 10 via respective inlets 22, 24.

The hydrogen is combined with the oxygen to provide steam to the inlet fan 14. As shown in FIG. 2, the steam is fed to the cylinders 16 via respective cylinder inlets 26a, 26b, 26c, 26d, 26e; each inlet comprising a one-way valve. Each inlet 26a, 26b, 26c, 26d, 26e is formed and arranged such that steam is only fed to the respective cylinder 16a, 16b, 16c, 16d, 16e at an appropriate stage of the cylinder cycle. That is, steam is fed to the cylinder 16a, 16b, 16c, 16d, 16e when a cylinder piston moves towards a lower portion of the cylinder 16a, 16b, 16c, 16d, 16e (e.g. intake stroke).

The steam is exhausted from the cylinders 16 via respective cylinder outlets 28a, 28b, 28c, 28d, 28e; each outlet comprising a one-way valve. Each outlet 28a, 28b, 28c, 28d, 28e is formed and arranged such that steam is only exhausted from the respective cylinder 16a, 16b, 16c, 16d, 16e at an appropriate stage of the cylinder cycle. That is, steam is only exhausted from the cylinder 16a, 16b, 16c, 16d, 16e when a cylinder piston moves towards an upper portion of the cylinder 16a, 16b, 16c, 16d, 16e during an exhaust stroke.

The exhaust fan 18 draws exhaust steam away from the cylinder outlet 28a, 28b, 28c, 28d, 28e. Cowling 30 within the motor housing 32 directs the exhaust steam towards the inlet fan 14 where the steam is recirculated through the cylinders 16a, 16b, 16c, 16d, 16e.

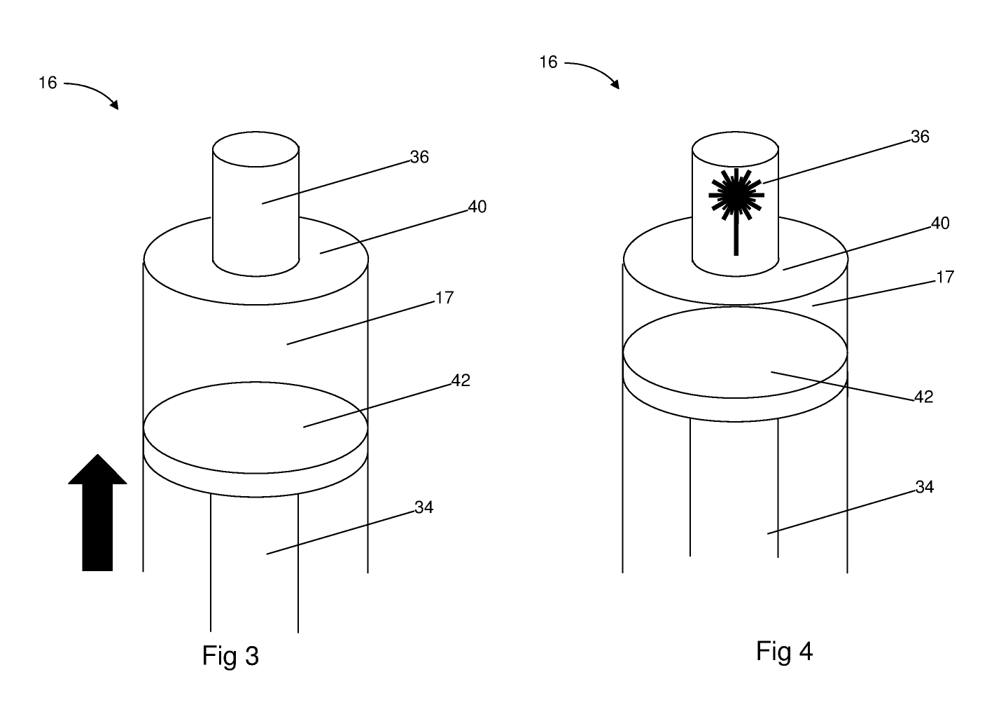

FIG. 3 is a view of the cylinder 16 of the apparatus of FIG. 1 in a first configuration. The piston 34 is at bottom dead centre and steam has been fed into the cylinder 16 via the cylinder inlet (not shown in FIGS. 3 to 6). The piston 34 starts a compression stroke as indicated by the arrow. As the piston 34 nears top dead centre, as shown in FIG. 4, a laser source 36 is activated such that a laser beam is directed into the cylinder chamber via a laser inlet. In the embodiment shown, the laser source 36 and the laser inlet are axially located relative to the cylinder 16.

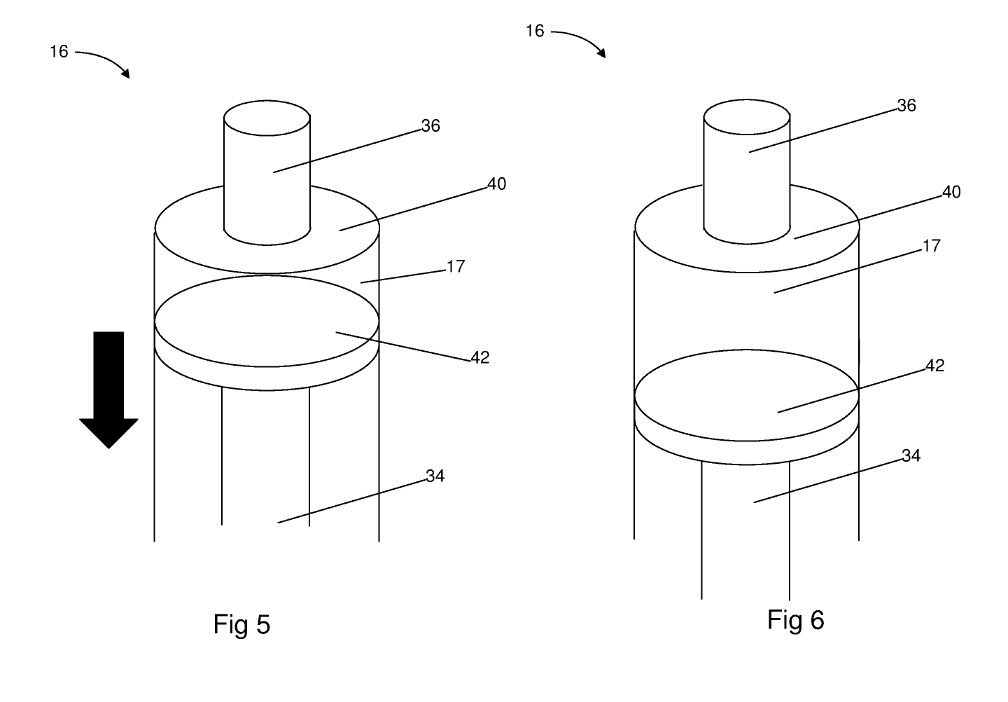

In the configuration of FIG. 4, the steam in the cylinder 16 is heated by the laser radiation. Accordingly the temperature of the steam is increased and consequently the pressure in the cylinder 36. The increased pressure in the cylinder 36 forces the piston 34 towards bottom dead centre as shown in FIG. 5, whereby mechanical energy is output from the cylinder 16, such as via a connecting rod to a crankshaft (not shown). In the embodiment shown, once the piston has reached the bottom dead centre position of FIG. 6, an exhaust stroke and intake stroke are completed prior to completing a further compression and power cycle as described with reference to FIGS. 3 to 5. In alternative embodiments, it will be appreciated that the motor may not comprise an exhaust stroke and that a same fluid, such as steam, may be recompressed and reheated within the cylinder 16 to generate a further power stroke.

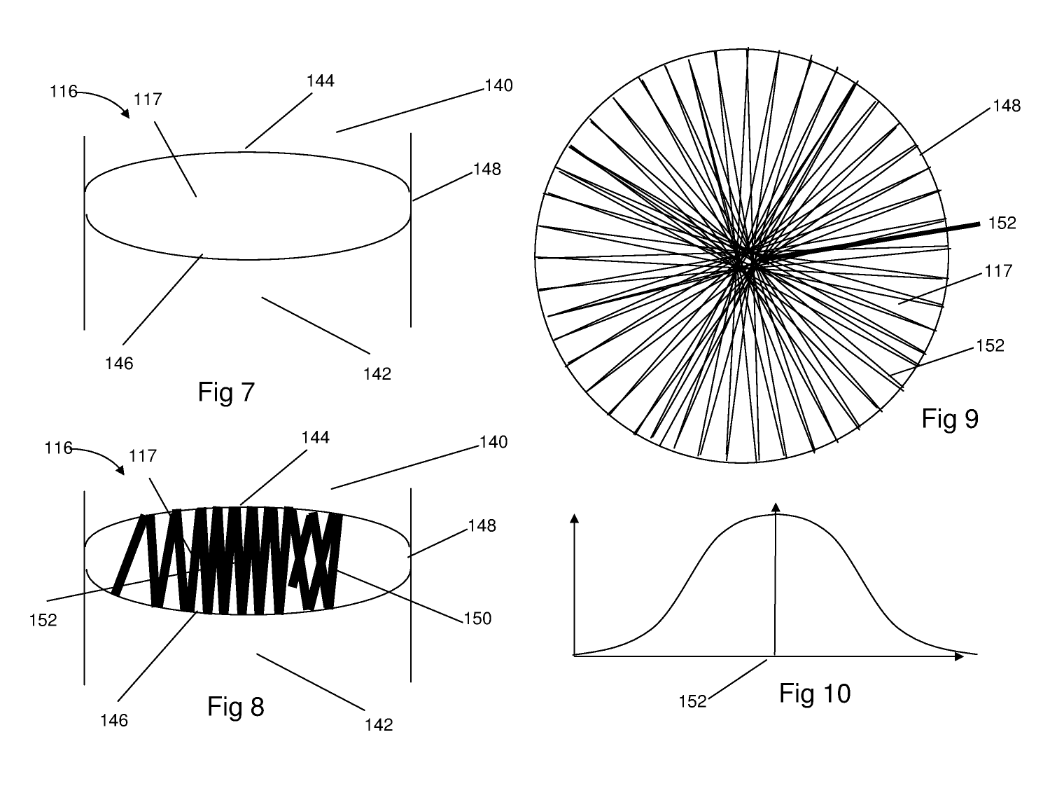

FIG. 7 shows a cross-sectional view of a cylinder 116 in accordance with an embodiment of the invention. In the embodiment shown, the cylinder 116 comprises a cylinder head 140 and a piston head 142, each comprising a respective concave surface 144, 146. FIG. 8 shows a portion of a radiation distribution in the cylinder chamber 117 of FIG. 7 at top dead centre. The concave surfaces 144, 146 are configured such that a volume of steam in the cylinder chamber 117 is radially concentrated towards the centre of the cylinder 116. Accordingly, the volume of steam is concentrated in a same portion of the cylinder 116 as a laser beam 150 upon activation as the piston 134 reaches top dead centre. The cylinder 116 further comprises a cylindrical side wall 148, which also constitutes a concave surface such that the laser beam is consistently redirected towards the central portion of the cylinder chamber 117; both laterally and axially by the concave surfaces 144, 146, 148.

FIG. 9 is a plan view of the cylinder 116 of FIG. 7, showing a portion of radiation distribution in the cylinder chamber 117. The concentration of the laser beam 150 towards the centre 152 of the cylinder chamber 117 due to the reflections from the concave surfaces 144, 146, 148. FIG. 10 graphically shows a radiation distribution across the cylinder chamber 117 according to radial distance from the centre 152. Accordingly, the laser beam 150 follows a path proportional to the distribution of steam in the cylinder chamber 117.

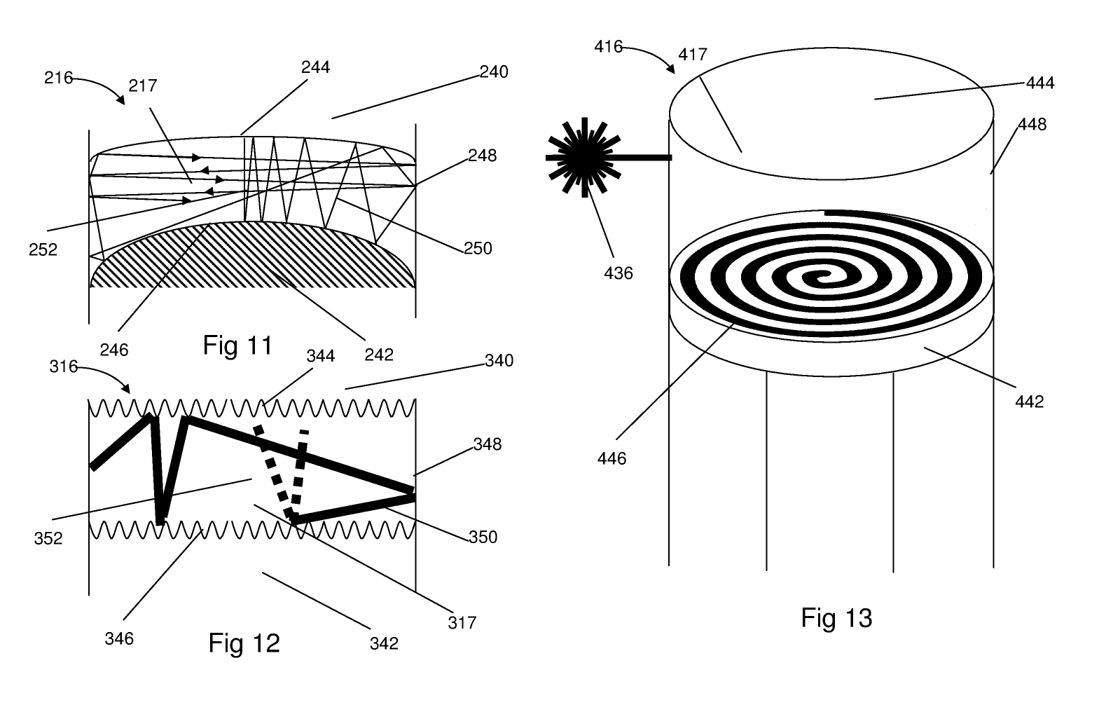

FIG. 11 shows a cross-sectional view of an alternative cylinder 216 in accordance with an embodiment of the invention, showing a portion of a radiation distribution in a cylinder chamber 217. In the embodiment shown, the cylinder head 240 comprises a concave surface 244 and the piston head 242 comprises a convex surface 246. The cylinder 216 further comprises a cylindrical side wall 248, which also constitutes a concave surface. The cylinder chamber 217 is configured such that the laser beam 250 is directed towards peripheral portions 254 of the chamber 217, away from the central portion 252. Accordingly, the laser beam 250 follows a path proportional to the distribution of steam in the cylinder chamber 217.

FIG. 12 is a cross-sectional view of a cylinder 316 in accordance with an embodiment of the invention, showing a portion of a radiation distribution 350 in a cylinder chamber 317. In the embodiment shown, the cylinder head 340 and piston head 342 comprise respective profiled surfaces 344 and 346. The profiled surfaces 344, 346 are configured according to the wavelength of the laser beam 350. The pitch of the profiled surfaces 344, 346 is such that the radiation beam 350 is dispersed throughout the chamber 317 to distribute the radiation evenly throughout the chamber 317.

A schematic example of a profiled surface 446 of a piston head 442 is shown in FIG. 13. The cylinder head 446 has been finely machined with a fine spiral pattern 470. The cylinder head 340 is shown with a circumferentially-mounted laser source 436.

It will be appreciated that the system may operate with a continuous supply of combustible fluid. It will also be appreciated that a system may operate with a closed circuit of heatable fluid. For example, an initial combustion process can provide the recirculatable combustible fluid until a desired pressure threshold is attained within the motor; at which stage no further fluid or fluid components need be supplied to the motor.

In alternative embodiments, the motor may utilise the laser source at discrete intervals to maintain the cylinder. For example, the laser source may be operable when the motor is inoperable, such as to clean and/or flush the cylinder chambers. The laser source may be directed into the cylinder chambers to ablate the cylinder chamber surfaces. The motor may be configured to routinely activate the laser source for such operation, such as upon shut-down of the motor and/or periodically.

It will be appreciated that any of the aforementioned apparatus may have other functions in addition to the mentioned functions, and that these functions may be performed by the same apparatus.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. It should be understood that the embodiments described herein are merely exemplary and that various modifications may be made thereto without departing from the scope of the invention. For example, where a four stroke process is described, it will be appreciated in alternative embodiments/modes of use, the cylinder may operate with alternative cycles, such as a two stroke process. Similarly, where a laser source has been shown, it will be appreciated that additional or alternative radiation may be supplied to the cylinder chamber by a maser source, such as a hydrogen maser.

1. An apparatus for providing mechanical energy, the apparatus comprising
a motor for providing mechanical energy, the motor comprising at least one chamber for receiving a fluid to be heated and/or combusted and/or compressed and/or expanded; and
an amplified stimulated emission radiation source for supplying radiation to the chamber.

2. The apparatus of claim 1, wherein the radiation source comprises a laser.

3. The apparatus of claim 1 or 2, wherein the radiation source comprises a maser.

4. The apparatus of any preceding claim, wherein the apparatus is configured to heat the fluid in the chamber with the radiation from the amplified stimulated emission radiation source.

5. The apparatus of any preceding claim, wherein the apparatus is configured to preheat the fluid in the chamber with the radiation from the amplified stimulated emission radiation source.

6. The apparatus of any preceding claim, wherein the apparatus is configured to heat the chamber with the radiation from the amplified stimulated emission radiation source.

7. The apparatus of any preceding claim, wherein the apparatus is configured to supply radiation to the chamber prior to and/or upon start-up.

8. The apparatus of any preceding claim, wherein the apparatus is configured to ignite the fluid in the chamber with the radiation from the amplified stimulated emission radiation source.

9. The apparatus of any preceding claim, wherein the apparatus is configured to maintain the chamber with the radiation from the amplified stimulated emission radiation source.

10. The apparatus of claim 9, wherein the apparatus is configured to clean the chamber with the radiation from the amplified stimulated emission radiation source, such as by ablation of a surface of the chamber.

11. The apparatus of any preceding claim, wherein the fluid comprises an inert fluid.

12. The apparatus of any preceding claim, wherein the fluid comprises water and/or steam.

13. The apparatus of any of claims 1 to 10, wherein the fluid comprises a combustible fluid.

14. The apparatus of claim 13, wherein the combustible fluid comprises hydrogen.

15. The apparatus of any preceding claim, wherein the motor comprises an internal combustion engine.

16. The apparatus of any preceding claim, wherein the motor comprises an external combustion engine.

17. The apparatus of any preceding claim, wherein the motor is configured to provide the amplified stimulated emission radiation to the chamber for a predetermined interval.

18. The apparatus of any preceding claim, wherein the motor is configured to provide the amplified stimulated emission radiation to the chamber at a predetermined phase or stage of a chamber cycle.

19. The apparatus of any preceding claim, wherein the motor comprises a cylinder defining the chamber, and a piston defining an end wall of the chamber.

20. The apparatus of claim 19, wherein the, the motor is configured to provide the amplified stimulated emission radiation to the chamber when the piston reaches a predetermined position, such as top dead centre.

21. The apparatus of any preceding claim, wherein the motor comprises a control system such that the radiation source and/or a radiation guide and/or a radiation inlet is activated at a predetermined piston position.

22. The apparatus of any preceding claim, wherein the radiation comprises a wavelength configured to heat the fluid.

23. The apparatus of any preceding claim, wherein the radiation comprises a wavelength configured to clean the chamber.

24. The apparatus of any preceding claim, wherein the radiation comprises multiple wavelengths.

25. The apparatus of claim 24, wherein the radiation at a first wavelength is more readily absorbed by the fluid than radiation at a second wavelength, such that the first wavelength is used to radiate the fluid in a first portion of the chamber; and the second wavelength is used to radiate the fluid in a second portion of the chamber.

26. The apparatus of any preceding claim, wherein the radiation is divergent.

27. The apparatus of any preceding claim, wherein the radiation comprises pulsed radiation and/or scanned radiation.

28. The apparatus of any preceding claim, wherein the motor comprises the radiation source.

29. The apparatus of any of claims 1 to 27, wherein the radiation source is remote from the motor.

30. The apparatus of any preceding claim, wherein the motor comprises a plurality of chambers, and each chamber comprises a discrete radiation source.

31. The apparatus of any of claims 1 to 29, wherein the motor comprises a plurality of chambers, and the motor is configured to supply radiation from a single radiation source to multiple chambers.

32. The apparatus of any preceding claim, wherein the motor comprises a hydrogen burner.

33. The apparatus of any preceding claim, wherein the motor is configured to supply an exhaust fluid from an external combustion compartment to the fluid chamber.

34. The apparatus of any preceding claim, wherein the motor is configured to recirculate the fluid.

35. The apparatus of any preceding claim when dependent on claim 3, wherein the maser comprises a hydrogen maser.

36. The apparatus of any preceding claim, wherein the motor is configured to distribute radiation throughout the chamber.

37. The apparatus of claim 36, wherein the motor is configured to distribute the radiation evenly.

38. The apparatus of claim 36, wherein the motor is configured to concentrate the radiation.

39. The apparatus of any preceding claim, wherein the motor is configured to distribute the radiation in the chamber according to a distribution of fluid in the chamber.

40. The apparatus of any preceding claim, wherein the motor is configured to sequentially radiate fluid in different portions of the chamber.

41. The apparatus of any preceding claim, wherein the motor is configured to radiate fluid within the chamber according to a change in volume of fluid in the chamber.

42. A method of providing mechanical energy, the method comprising:
supplying radiation from an amplified stimulated emission radiation source to a chamber of a motor;
heating and/or igniting and/or pressurising a fluid in the chamber with the radiation ; and/or
heating and/or maintaining the chamber with the radiation.

43. A motor chamber for providing mechanical energy, the chamber being for receiving a fluid to be heated and/or combusted and/or compressed and/or expanded, wherein the chamber is configured to distribute radiation from an amplified stimulated emission radiation source to heat and/or combust and/or pressurise the fluid; and/or to radiate the chamber.

44. The chamber of claim 43, wherein the chamber is configured to distribute radiation throughout the chamber.

45. The chamber of claim 43 or 44, wherein the chamber is configured to concentrate the radiation.

46. The chamber of any of claims 43 to 45, wherein the chamber is configured to sequentially radiate fluid in different portions of the chamber.

47. The chamber of any of claims 43 to 46, wherein the chamber is configured to progressively radiate fluid in different portions of the chamber.

48. The chamber of any of claims 43 to 47, wherein the chamber is configured to radiate fluid within the chamber according to a change in volume of fluid in the chamber.

49. The chamber of any of claims 43 to 48, wherein the chamber comprises a concave surface.

50. The chamber of any of claims 43 to 49, wherein the chamber comprises a convex surface.

51. The chamber of any of claims 43 to 50, wherein the chamber comprises a moveable wall and the moveable wall comprises an axially and/or laterally and or rotationally asymmetric profile relative to a longitudinal axis of the chamber.

52. The chamber of any of claims 43 to 51, wherein the chamber comprises a reflective surface.

53. The chamber of claim 52, wherein the chamber comprises a mirror configured to reflect the radiation.

54. The chamber of any of claims 43 to 53, wherein the chamber comprises a profiled surface.

55. The chamber of claim 54, wherein a magnitude and/or a pitch of the profiled surface is configured according to the radiation wavelength/s. For example, the profiled surface may comprise a structure with a pitch and/or order of magnitude larger than the radiation wavelength/s. The profiled surface may comprise a structure with a pitch and/or order of magnitude larger similar to the radiation wavelength/s. The profiled surface may comprise a structure with a pitch and/or order of magnitude less than the radiation wavelength/s.

56. The chamber of claim 54 or 55, wherein the magnitude and/or pitch of the profiled surface is configured according to the beam diameter and/or width.

57. The chamber of any of claims 43 to 56, wherein the chamber is configured to be ablated by the radiation. For example, the chamber may be configured such that radiation reaches substantially the entire surface/s of the chamber.

58. The chamber of any of claims 43 to 57, wherein the chamber is configured such that the chamber surface/s receive/s a substantially homogenous dosage of radiation.

59. The chamber of any of claims 43 to 58, wherein the chamber is microscopic.

60. The chamber of any of claims 43 to 58, wherein the chamber is nanoscopic.
